(19) United States
(12) Patent Application Publication
(10) Pub. No.: US 2002/0126298 A1
(43) Pub. Date: Sep. 12, 2002

(54) Raster plotter

(76) Inventors: Mario Andrada Galan, Madrid (ES); Bernardo Alcantara Perez, Madrid (ES); Jose Ramon Perez Gonzalez, Madrid (ES)

Correspondence Address: REED SMITH LLP, Patent, Trademark and Copyright Matters, 375 Park Avenue, New York, NY, 10152, US

(21) Appl. No.: 09/908,362

(22) Filed: Jul. 18, 2001

(30) Foreign Application Priority Data
Jul. 19, 2000 (ES) 200001800

(51) Int. Cl. G06F 15/00

(52) U.S. Cl. 358/1.3

(57) ABSTRACT

A raster-type drawing machine (plotter), automatically controlled from a controller, which consists in a tubular structure of rigid elements that join and support the elements of feeding, printing, advancement, and collection of sheet material. The sheet-paper-collection and feeding modules are formed by a set of rollers and disks that support the sheet material. The controlled one-way movement of the sheet material in the direction X is carried out through two rollers whose length is much smaller than the width of the material to be printed. The machine includes guides fixed to its structure through which a carriage set carrying the print heads moves according to axis Y.

### CROSS-REFERENCE TO RELATED APPLICATIONS

This application claims priority of Spanish Application No. 200001800, filed Jul. 19, 2000, the complete disclosures of which are hereby incorporated by reference.

### BACKGROUND OF THE INVENTION

a) Field of the Invention

The invention is generally directed to a raster-type plotter automatically controlled from a controller, which consists of a tubular structure of rigid elements that join and support the elements of feeding, printing, advancement, and collection of the sheet material. The sheet-paper-collection and feeding modules are formed by a set of rollers and disks that support the sheet material. The controlled one-way movement of the sheet material in direction X is carried out through two rollers whose length is much smaller than the width of the material to be printed. The machine includes guides fixed to its structure through which a carriage set carrying the print heads moves according to axis Y.

In particular, the present invention relates to a raster drawing machine, also known as a plotter. The drawing is traced by the combined action of the movement of a print head in the direction transverse to the advancement of the paper and the firing of drops of ink in the correct position, from the openings in the aforementioned print head. The plotter of the present invention is especially applicable for making very long drawings over elongated surfaces of sheet material, where the drawing is progressively traced from one of its ends to the other in combination with the movement of the sheet material over the supporting surface.

The plotter is especially applicable to the manufacturing industry where a sheet material, preferably very wide paper, is used for drawing of markings with patterns.

b) Description of the Related Art

Drawing plotters are well known as machines that make graphic representations of designs obtained in different areas of the industry, such as engineering, cartography, garment preparation, furniture, etc.

As a reference to the form and size of the paper used, there are two types of plotters, those that use paper cut to the dimensions of the drawing to be made, or those that use continuous paper or paper in rolls. The first ones have the limitation of normally involving standardized dimensions of paper up to one meter long, or they need tables as large as the area of the drawing to be made, with the consequent high price of the plotter. The second ones make the drawing by the combined movement of the paper and the drawing utensil, but they need a very precise two-way control of the movement of the paper.

The types of machines described above are known as flat plotters and drum plotters, whose technology is known, as can be seen in the patents: U.S. Pat. No. 3,857,525; ES 509,082; U.S. Pat. No. 4,593,469.

To solve the problems inherent to both, several types of plotters were developed, which did the drawing on a table smaller than the maximum dimension of the drawing to be realized. The total operation was realized over successive zones, shifting the paper already drawn upon to a storage zone and presenting an area of new paper in the work zone. This required few but precise joinings, as is seen in patents U.S. Pat. Nos. 4,901,980, 4,916,819.

In any case, the yield of this type of machine known as vectorials, in meters of paper drawn per unit of time, depends heavily on the density of the drawing to be realized. Furthermore, due to the precision required, the moving masses must be as small as possible.

The drawbacks of vectorial plotters are avoided with raster-type plotters, with which the drawing is realized by the combined action of the movement of the print heads and the advancement of the paper in a staggered form, as appears in U.S. Pat. No. 4,686,540, and in EP 08812820A2.

The yield of the raster-type plotters is closely related to the width of the swept zone. On the other hand, until now drawing has been done on the perimeter of a cylindrical surface, in which the distance from the print head to the paper is not constant. These two facts translate into low yields and qualities of drawings.

U.S. Pat. No. 4,686,540 uses several heads spaced apart from each other in the sense of the movement of the set of them, so that as the length of the shifting of the set diminishes, productivity increases. On one hand this solution has the drawback that the carriage carrying the print heads is excessively large and, therefore, the movable mass is high; on the other hand there is a decrease in quality due to the excessive number ofjoinings not only in the advancements of the paper but also in the joining of the information drawn by each head.

### OBJECT AND SUMMARY OF THE INVENTION

The primary object of the present invention is to resolve the drawbacks presented above, while obtaining a high yield and quality of drawing, as described below.

In accordance with the invention, a raster-type drawing machine (plotter) is automatically controlled from a controller. The machine consists in drawing instruments supported by a carriage unit (4) that shifts in direction Y over guides fixed to the structure (6). The movement of the paper in direction X, that is, the lengthwise direction of the paper to be drawn upon, is carried out through the rotation of rollers (44), (45), which grasp the sheet material (5) and drag it in a controlled fashion until it exactly reaches the new position according to axis X; this advancement is equal to the width of the sweep of the heads. The heads are of the linearly grouped type of openings, the width of the sweep being the length of said linear grouping. The drawing is made as the heads print the information generated by the controller onto the sheet material (5) that sequentially appears in the printing zone. The sheet material slides over a flat zone (85) to which it is adhered by vacuum action generated by an aspirator (80) through the grooves (82).

### BRIEF DESCRIPTION OF THE DRAWINGS

In the drawings:

FIG. 1 illustrates a general perspective view of the entire plotter;

FIG. 2 is a diagram of a section along plane A of FIG. 1 that shows the paper-feeding, dragging, and collection mechanism of the invention;

FIG. 3 is a view of the feeding module sectioned along plane A of FIG. 1;

FIG. 4 is a view of the paper-carrying unit sectioned along a longitudinal mid plane;

FIG. 5 is a view of the paper-dragging mechanism sectioned along plane A of FIG. 1;

FIG. 6 is a view of the transmission of the drag mechanism sectioned along the longitudinal mid plane of the roller;

FIG. 7 is a view of the collection module sectioned along plane A of FIG. 1;

FIG. 8 is a view sectioned along a mid plane of the collection unit axle;

FIG. 9 is a view in perspective of the system for setting the paper in the writing zone; and

FIG. 10 is a schematic view of the mechanism of the carriage unit.

### DESCRIPTION OF THE PREFERRED EMBODIMENTS

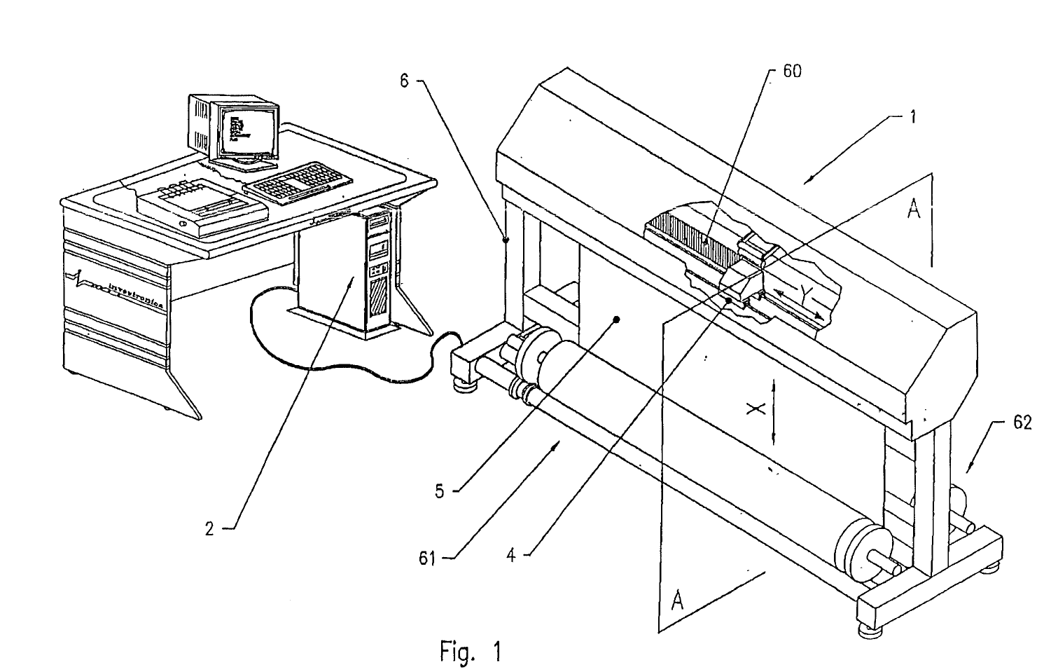

FIG. 1 shows the general view of the entire machine (1). The plotter (1) includes a computer (2) for handling data and connecting to the database of the CAD system. The plotter includes a head of the linear grouping type assembled over a carriage unit (4) that supports it and shifts it in the direction of axis Y. The head (10) is preferably of the “drop on demand” type, although it could be of any other type. The head (10) prints on the zone of sheet material (5) exposed to its sweep. The structure (6) of the plotter consists of rigid tubular elements that join the elements of the printing zone (60) with the feeding (61) and collection (62) zones in a rigid and dimensionally stable form.

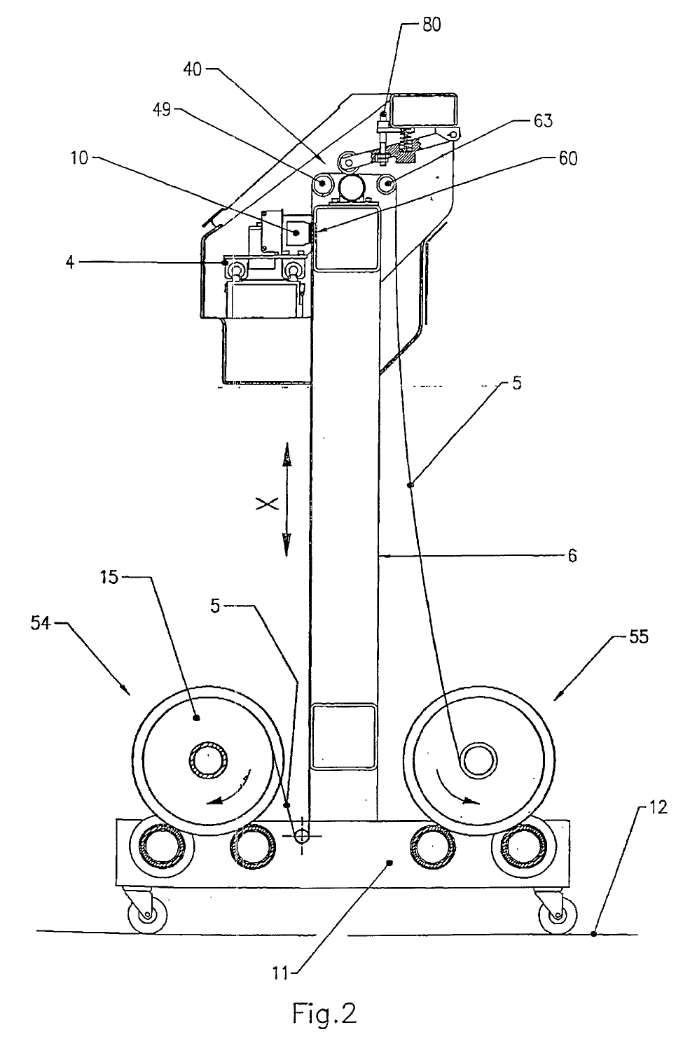

In FIG. 2 a view sectioned along plane A of FIG. 1 of a plotter is shown, and the fundamental elements of the paper-feeding, dragging, and collection mechanism are viewed schematically. A carriage unit (4) is observed, which moves in direction Y and over which a print head (10) is arranged. At base (11) of the structure (6), close to floor level (12), at a height that can of course be smaller than the diameter of the roll (15) to facilitate loading and unloading of the sheet material (5), the feeding module (54) and the collection module (55) are arranged. The sheet material (5) is normally supplied in a roll (15), although the plotter can work on loose sheets, for example of dimension DIN A0; however, all subsequent description is based on reels (15). In this figure the run of the paper (5) from the feeding module (54) to the collection module (55), passing over the printing zone (60) guided by axles (51, 63) and through the dragging mechanism (40) can be appreciated

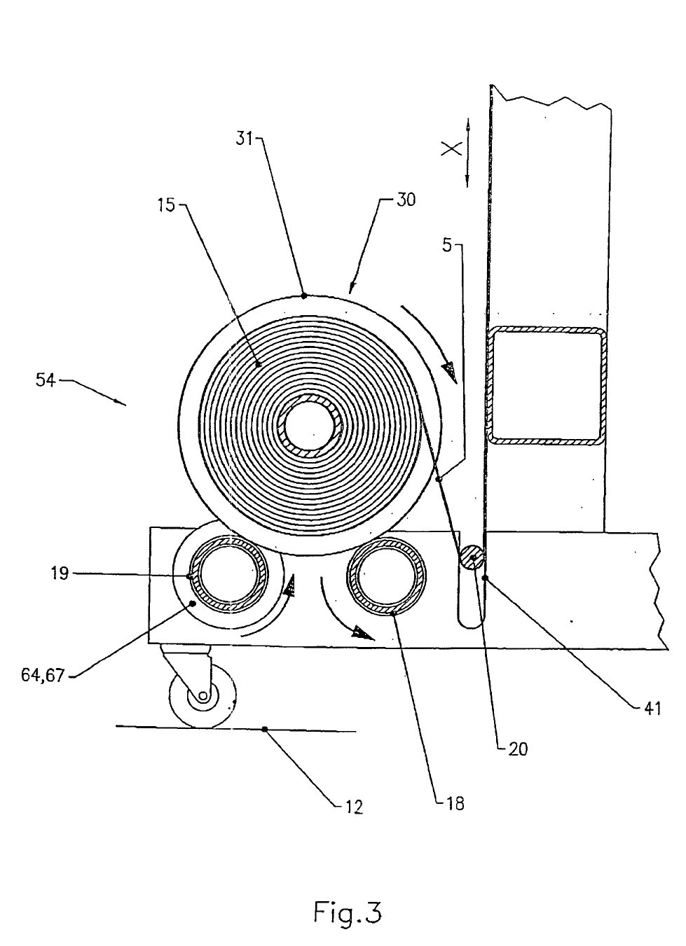

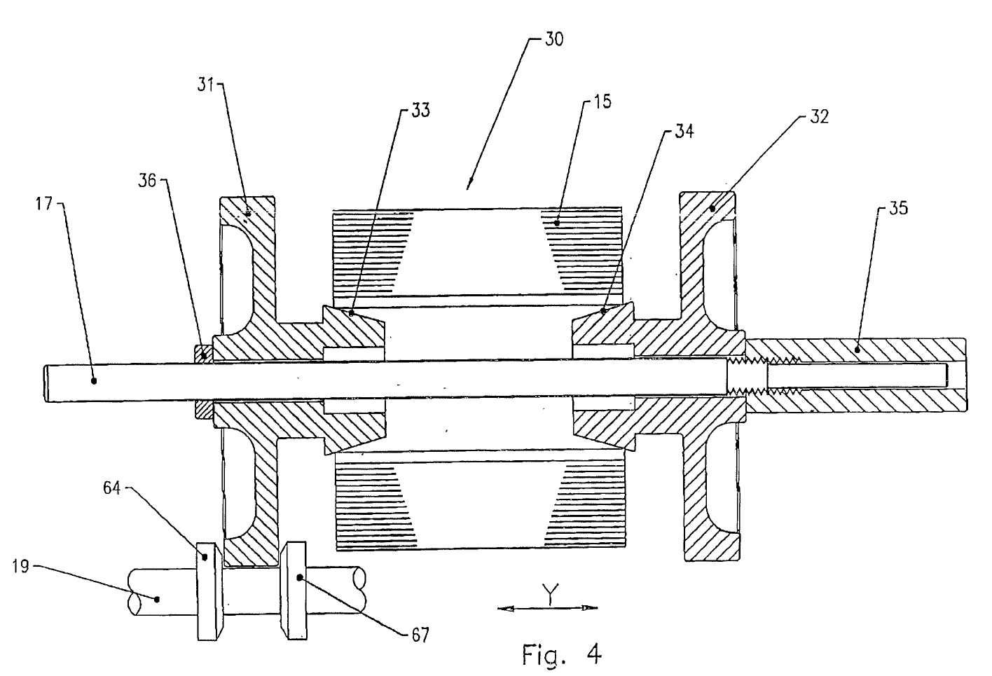

In FIG. 3 the feeding module (54) is shown, consisting of two rollers (18, 19) that serve to support disks (31, 32) (FIG. 4) of the unit carrying unit (30) of the roll (15) of sheet material (5). Roller (18) is motorized, whereas roller (19) turns freely. The module has a bar (20) that is found ahead of the advancement mechanism (40) and is guided laterally in the groove (41). The bar (20) ensures practically constant tension proportional to its weight on the sheet material (5). On one of the rollers, in this case (19), two rings (64, 67) are situated, attached to the roller (9) and serving to guide the carrying unit (30) of the roll (15) laterally, impeding its movement according to axis Y.

FIG. 4 shows the carrying unit (30) carrying of the roll (15) of paper (5) sectioned according to a longitudinal mid-plane of the roll (15) consisting of the two disks (31, 32), with a grooved conical side (33, 34) and an axle (17) that joins them. The unit works by tractioning the axle (17) between the two disks (31, 32) by means of a grip control (35), which is screwed onto the axle (17) because the disk (31) has kept it from shifting along the axle (17) by means of the ring (36) solidly joined to the axle (17); thus the roll (15) of sheet material (5) is solidly fixed to the feeding axle (17), grasping it between the conical surfaces (33, 34) of the disks (31, 32). This system allows the weight of the feeding axle (17) to be reduced, given that it must be rigid only in traction and not in traction and flexion, as usually occurs. Rigidity in flexion is provided to it by the roll (15) of paper itself.

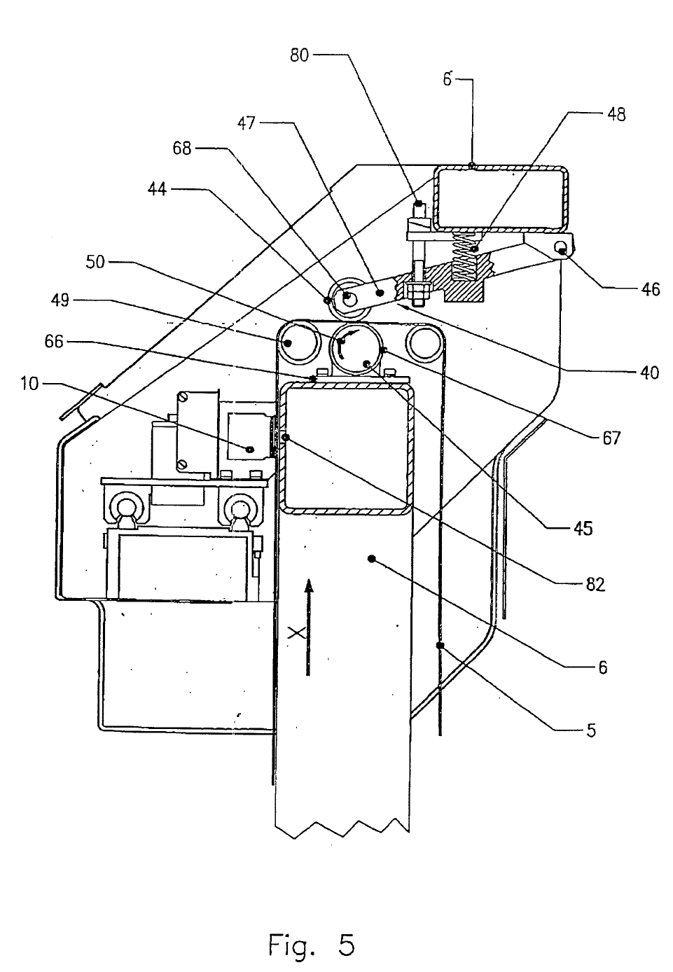

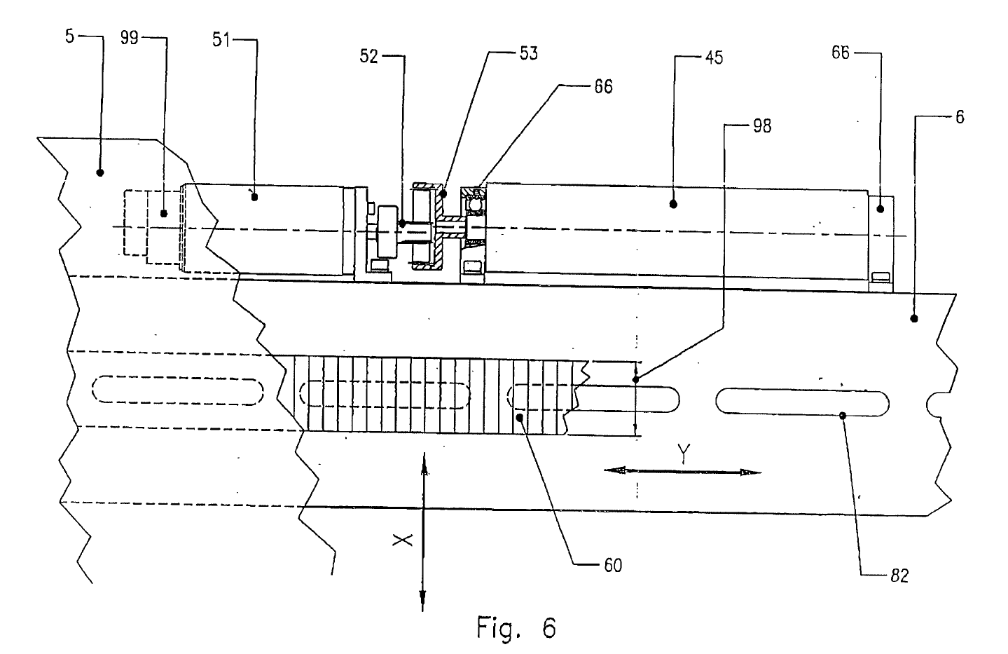

FIG. 5 shows the advancement mechanism (40) of the paper (5), consisting of two rollers (44, 45). The lower roller (45) is supported on the bearings of two supports (66) fixed to the structure (6). The upper roller (44) turns freely on axle (68) and is supported on a lever (47) joined to axle (46). The upper roller (44) applies the pressure necessary to advance the paper (5) due to the force of the spring (48), which acts between the lever (47) that supports it and the structure (6). The pressure roller unit includes a tilting mechanism activated by a lever (80) that allows the roller (44) to be released from the pressure of the spring (48) so that the upper roller (44) is raised, separating from the lower roller (45) and leaving enough of a gap between them for the paper (5) to pass, and to allow easy loading of the paper. The sheet material (5) moves in one direction, advancing in direction X by a distance equal to the width of the sweep (98) (FIG. 6) of the head (10). The advancement is realized in a controlled and exact form. This control is effected by means of the information of the counter (99) (FIG. 6) integrated on the axle of the motor (51) (FIG. 6) which moves as ordered by the controller. The paper-guiding axle (49) is supported at its ends in the structure (6) and has a central support that is positioned to ensure that the paper moves according to an axis perpendicular to the generatrix of the roll (15).

FIG. 6 shows the mechanism of activation of the lower roller (45) that is the traction element of the paper (5). The couple necessary to produce the turn (50) (FIG. 5) is due to the motor (51) that acts on it through a reduction of gears (52, 53). In this figure the openings (82) that allow the paper (5) to be set over the printing zone (60) are also observed.

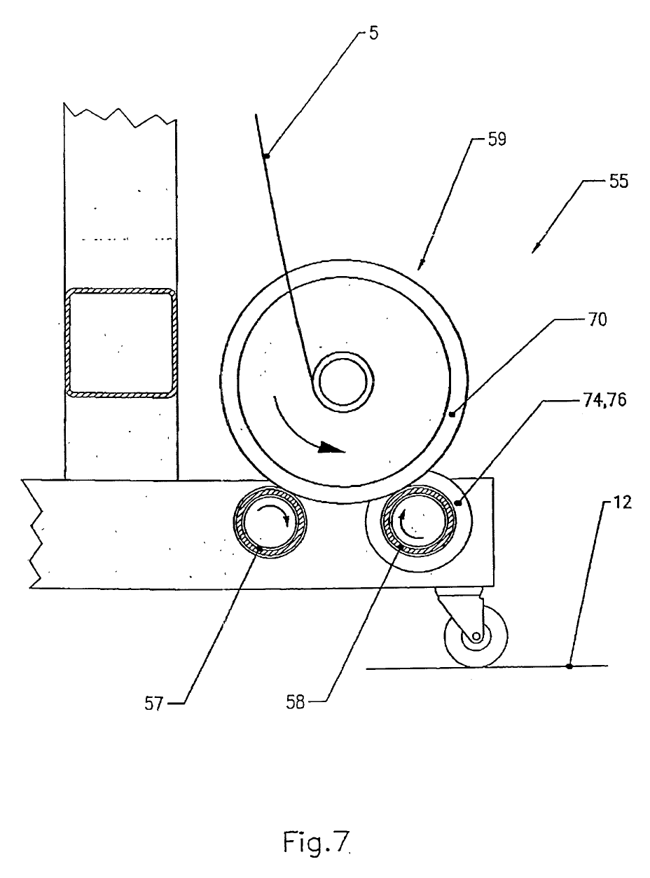

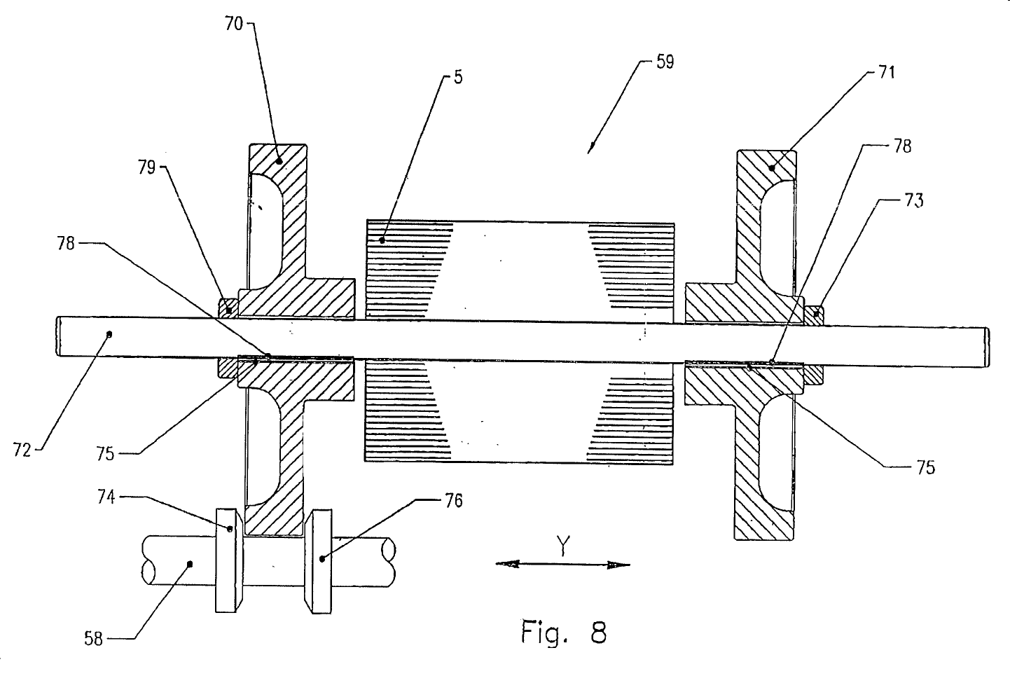

FIG. 7 shows the paper-collection module (55) that consists of two rollers (57, 58) supporting the axle unit (59) for collection of paper (5). Like those of the feeding module, one (57) of these rollers (57, 58) is motorized and the other (58) free; end disks (70) and (71) of the collection axle unit (59) rest on them (FIG. 8).

In FIG. 8 a view sectioned along a mid plane of the axle (72) of the collection axle unit (59) is seen. At the surface (75) corresponding to the interior diameter of the disks (70), (71), the surface (78) of the axle (72) is supported, and the paper (5) is collected on axle (72). The disks (70), (71) of the collection axle unit (59) are found to rotate continuously through contact with the motorized axle (57) (FIG. 7). The disks (70, 71) transmit the rotating movement to the axle (72) by friction between the surfaces (75, 78). The movement of the axle (72) collects the paper (5) with a couple always below that which allows the force of friction established between the surface (78) of the axle and (75) of the disk, this union thus acting as a couple limiter. There are two stops (73, 79) that keep the disks (70, 71) from shifting in the longitudinal direction of the axle. The paper (5) is wound over the axle (72) in the space limited by the disks (70), (71). Stops (74, 76), adjustable over the roller (58), prevent the unit (59) from shifting laterally.

The feeding module system is also applicable to the collection module.

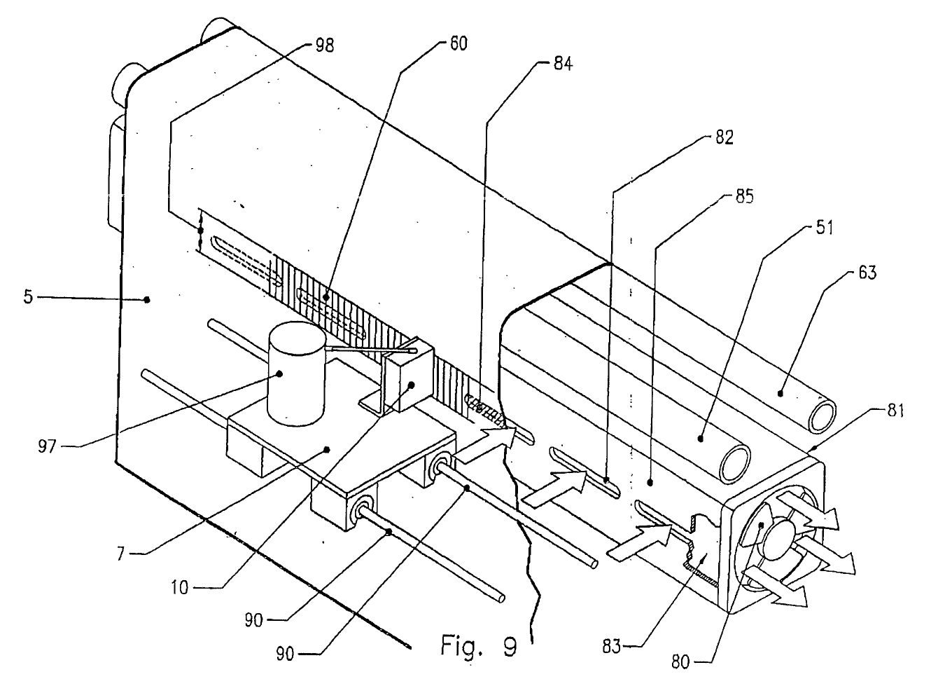

FIG. 9 shows the system for setting the paper (5) in the printing zone (60), which is realized through suction produced by a small aspirator (80). The support surface (85) of the paper (5) is situated over an aspiration chamber (81) that has apertures (82) that put the inside (83) of the aspiration chamber (81) in communication with the surface (84) of the paper. Thus the paper (5) is held against the support surface (85), ensuring a fixed distance between the head (10) and the paper (5), which guarantees writing of uniform quality.

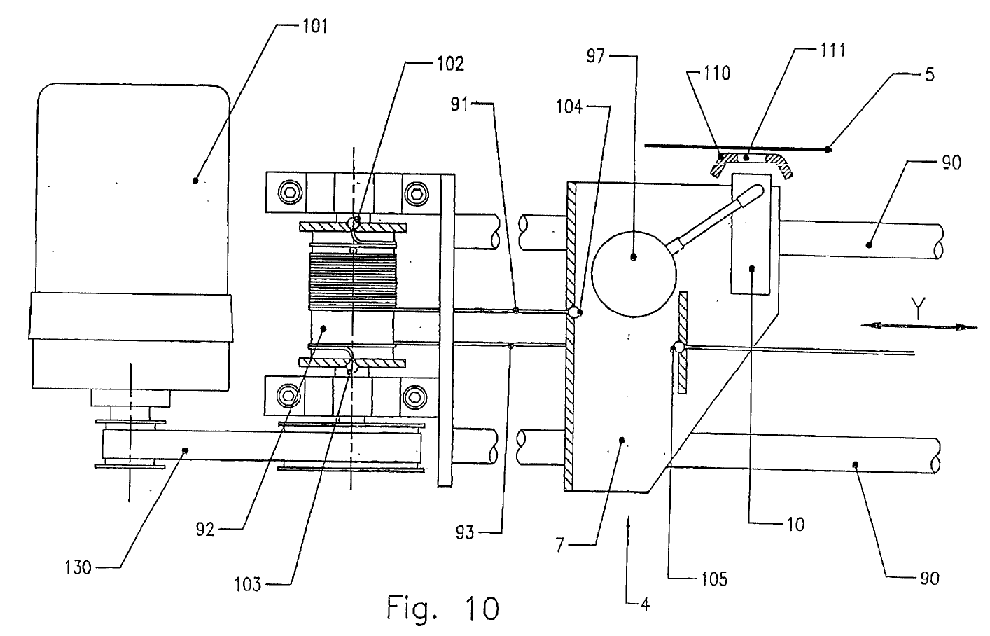

In FIG. 10 the mechanism of movement of the carriage unit (4) can be seen. The movement of the carriage unit (4) is produced by the couple provided by the motor (101), which is controlled in position and speed. The motor (101), through a belt (130), transmits the movement to the motor pulley (92). The carriage (7) receives the movement through flexible cables (91, 93) whose ends (102, 103) are joined to the motor pulley (92). The other two ends (104, 105) of the cables are joined to the carriage (7). The carriage (7) shifts in direction Y over two guides (90) perpendicular to direction X of advancement of the paper. During that shift the zone of paper (5), which is exposed as it passes, is printed. After each shift, paper (5) advances in direction X, equal in length to the width of the sweep (98) (FIG. 9) of head (10). The shift of the paper leaves a new zone exposed for the next writing. The print head (10) has a block (110) with a small opening (111) corresponding to the linear grouping of openings that allows the drops of ink to pass through, and whose surface is exterior to the surface of the plate of openings so that the sheet material (5) never comes into contact with the plate of openings. The system of feeding ink to the head (10) consists of a reservoir (97) close to the print head (10). The reservoir and the head (10) are connected through a flexible tube that guarantees tightness to air and ink.

While the foregoing description and drawings represent the present invention, it will be obvious to those skilled in the art that various changes may be made therein without departing from the true spirit and scope of the present invention.

15. (New) A raster-type plotter comprising:
a tubular structure that establishes a surface of support and setting for drawing of paper;
said tubular structure situated over a flat zone that includes:
an aspiration chamber;
means for feeding, advancement, and collection of the sheet material; and
a carriage that shifts according to a direction Y, which includes a print head and means for drawing on the sheet material.

16. (New) The raster-type plotter according to claim 15, wherein said means for paper feeding and collection are close to ground level, at a height lower than the diameter of a roll.

17. (New) The raster-type plotter according to claim 15, wherein the system for setting the paper in the printing zone includes an aspiration chamber that has several openings that put the inside of the chamber in communication with the surface of the paper, and an aspirator that produces the vacuum in said chamber.

18. (New) The raster-type plotter according to claim 15, wherein the paper-feeding module consists of two rollers and that one of them is motorized whereas the other turns freely, and that the carrying unit of the roll is supported on said rollers.

19. (New) The raster-type plotter according to claim 18, wherein the feeding module includes a bar that is situated between the feeding module and the advancement mechanism of the paper.

20. (New) The raster-type plotter according to claim 18, wherein the roll-carrying unit consists of two disks with a conical side and an axle that crosses them, and wherein the axle incorporates into one of its ends a threaded grip control and on the other end of the axle it incorporates a ring adjustable to the axle.

21. (New) The raster-type plotter according to claim 18, incorporating two adjustable rings over either one of rollers to guide the roll-carrying unit laterally according to the Y direction.

22. (New) The raster-type plotter according to claim 18, wherein the paper-advancement mechanism consists of two rollers between which the paper is grasped, the length of the rollers being much smaller than the width of the paper to be drawn upon, and wherein both rollers are symmetrically centered with respect to the width of the paper, an upper roller of said rollers rotating freely, the lower roller being motorized.

23. (New). The raster-type plotter according to claim 15, wherein the upper roller turns freely on its axis and is supported over a joined lever that incorporates a spring between the lever and the structure, which graduates the pressure of the upper roller over the paper and against the surface of the lower roller.

24. (New) The raster-type plotter according to claim 22, wherein the paper-guiding axle that rotates freely, is supported at its ends on structure and has a central support positioned to ensure the movement of the paper according to an axis perpendicular to the generatrix of roll.

25. (New) The raster-type plotter according to claim 22, wherein the paper-collection module is constituted by two rollers one of which is motorized and the other of which turns freely, and wherein the disks of the collection axle unit are supported on said rollers.

26. (New) The raster-type plotter according to claim 15, wherein the collection axle unit is formed by two disks, one axle that traverses them, and two rings inserted onto said axle that limits the shifting of the disks along the axle; and wherein the aforementioned disks rotate continually due to contact with the surface of the rollers, and wherein the diameter of the hole in the disks of passage of said axle is greater than the diameter of said axle, said axle in turn, rotates due to contact with the surfaces of the disks.

27. (New) The raster-type plotter according to claim 25, wherein the collection model also incorporates two rings adjustable over one of the rollers or to avoid the shifting of the collection axle unit according to the direction Y.

28. (New) The raster-type plotter according to claim 25 wherein the carriage unit moves by flexible cables, ends of which are joined to the motor pulley and to the carriage respectively, and wherein the motor pulley receives the movement through a belt
